(19) United States
(12) Patent Application Publication
(10) Pub. No.: US 2019/0344236 A1
(43) Pub. Date: Nov. 14, 2019

(54) A METHOD OF MAKING A POLYCRYSTALLINE SUPER HARD CONSTRUCTIONS

(71) Applicant: ELEMENT SIX (UK) LIMITED, DIDCOT, OXFORDSHIRE (GB)

(72) Inventors: DONG WANG, DIDCOT (GB); MIRIAM MIRANDA-FERNANDEZ, DIDCOT (GB)

(73) Assignee: ELEMENT SIX (UK) LIMITED, DIDCOT, OXFORDSHIRE (GB)

(21) Appl. No.: 16/474,140

(22) PCT Filed: Dec. 28, 2017
(86) PCT No.: PCT/EP2017/084731

§ 371 Date: Jun. 27, 2019

(30) Foreign Application Priority Data
Dec. 31, 2016 (GB) 1622467.7

(51) Int. Cl. B01J 3/06; C04B 35/528; C04B 35/5831; C04B 35/645

(52) U.S. Cl. CPC B01J 3/062; C04B 35/528; C04B 35/5831; C04B 35/645; C04B 2235/386; B01J 2203/0655; B01J 2203/0645; C04B 2235/427; B01J 2203/0615

(57) ABSTRACT

A method of forming polycrystalline diamond comprised placing a plurality of graphene nano-platelets into a capsule; and subjecting the platelets to a pressure of around 10 GPa to around 20 GPa and a temperature of around 1600 degrees Celsius to around 3000 degrees Celcius to convert the graphene platelets to nano-polycrystalline diamond. There is also disclosed a polycrystalline super hard construction comprising a polycrystalline diamond region comprising polycrystalline diamond material formed according to said method.

### FIELD

This disclosure relates to super hard constructions and methods of making such constructions, particularly but not exclusively to constructions comprising polycrystalline diamond (PCD) structures which may or may not be attached to a substrate, and tools comprising the same, particularly but not exclusively for use in rock degradation or drilling, or for boring into the earth.

### BACKGROUND

Polycrystalline super hard materials, such as polycrystalline diamond (PCD) may be used in a wide variety of tools for cutting, machining, drilling or degrading hard or abrasive materials such as rock, metal, ceramics, composites and wood-containing materials. In particular, tool inserts in the form of cutting elements comprising PCD material are widely used in drill bits for boring into the earth to extract oil or gas. The working life of super hard tool inserts may be limited by fracture of the super hard material, including by spalling and chipping, or by wear of the tool insert.

Cutting elements such as those for use in rock drill bits or other cutting tools typically have a body in the form of a substrate which has an interface end/surface and a super hard material which forms a cutting layer bonded to the interface surface of the substrate by, for example, a sintering process. The substrate is generally formed of a tungsten carbide-cobalt alloy, sometimes referred to as cemented tungsten carbide and the super hard material layer is typically polycrystalline diamond (PCD), or a thermally stable product TSP material such as thermally stable polycrystalline diamond.

Polycrystalline diamond (PCD) is an example of a super hard material (also called a super abrasive material or ultra hard material) comprising a mass of substantially inter-grown diamond grains, forming a skeletal mass defining interstices between the diamond grains. PCD material typically comprises at least about 80 volume % of diamond and is conventionally made by subjecting an aggregated mass of diamond grains to an ultra-high pressure of greater than about 5 GPa, and temperature of at least about 1,200° C., for example. A material wholly or partly filling the interstices may be referred to as filler or binder material.

PCD is typically formed in the presence of a sintering aid such as cobalt, which promotes the inter-growth of diamond grains. Suitable sintering aids for PCD are also commonly referred to as a solvent-catalyst material for diamond, owing to their function of dissolving, to some extent, the diamond and catalysing its re-precipitation. A solvent-catalyst for diamond is understood be a material that is capable of promoting the growth of diamond or the direct diamond-to-diamond inter-growth between diamond grains at a pressure and temperature condition at which diamond is thermodynamically stable. Consequently the interstices within the sintered PCD product may be wholly or partially filled with residual solvent-catalyst material. Most typically, PCD is often formed on a cobalt-cemented tungsten carbide substrate, which provides a source of cobalt solvent-catalyst for the PCD. Materials that do not promote substantial coherent intergrowth between the diamond grains may themselves form strong bonds with diamond grains, but are not suitable solvent-catalysts for PCD sintering.

To mitigate the problems associated with thermal degradation in such PCD materials, due to the presence of binder-catalyst material, one known method is to synthesise nanopolycrystalline diamond (NPD) by converting polycrystalline graphite into pure polycrystalline diamond. Such material does not comprise binder catalyst material and is typically optically transparent having a structure consisting of both granular grains having a grain size of below around 30 nm and lamellar grains. The synthesis conditions required to achieve such a conversion are a pressure of between around 12 GPa to 25 GPa at temperatures of over 2300 degrees Celcius. These extremely synthesis conditions are an obstacle for large-scale production of NPD.

Ever increasing drives for improved productivity in the earth boring field place ever increasing demands on the materials used for cutting rock. Specifically, PCD materials with improved abrasion and impact resistance are required to achieve faster cut rates and longer tool life.

Cutting elements or tool inserts comprising PCD material are widely used in drill bits for boring into the earth in the oil and gas drilling industry. Rock drilling and other operations require high abrasion resistance and impact resistance. One of the factors limiting the success of the polycrystalline diamond (PCD) abrasive cutters is the generation of heat due to friction between the PCD and the work material. This heat causes the thermal degradation of the diamond layer. The thermal degradation increases the wear rate of the cutter through increased cracking and spalling of the PCD layer as well as back conversion of the diamond to graphite causing increased abrasive wear.

Methods used to improve the abrasion resistance of a PCD composite often result in a decrease in impact resistance of the composite.

The most wear resistant grades of PCD usually suffer from a catastrophic fracture of the cutter before it has worn out. During the use of these cutters, cracks grow until they reach a critical length at which catastrophic failure occurs, namely, when a large portion of the PCD breaks away in a brittle manner. These long, fast growing cracks encountered during use of conventionally sintered PCD, result in short tool life.

Furthermore, despite their high strength, polycrystalline diamond (PCD) materials are usually susceptible to impact fracture due to their low fracture toughness. Improving fracture toughness without adversely affecting the material's high strength and abrasion resistance is a challenging task.

There is therefore a need for a super hard composite such as a PCD composite that has good or improved abrasion, fracture and impact resistance and a method of forming such composites.

### SUMMARY

Viewed from a first aspect there is provided a method of forming polycrystalline diamond, comprising:
placing a plurality of graphene nano-platelets into a capsule; and
subjecting the platelets to a pressure of around 10 GPa to around 20 GPa and a temperature of around 1600 degrees Celsius to around 3000 degrees Celcius to convert the graphene platelets to nano-polycrystalline diamond.

Viewed from a further aspect there is provided a polycrystalline super hard construction comprising a polycrystalline diamond region comprising polycrystalline diamond material formed according to the above defined method.

Viewed from a further aspect there is provided a tool comprising a body of polycrystalline diamond material formed according to above defined method, the tool being for cutting, milling, grinding, drilling, earth boring, rock drilling or other abrasive applications.

The tool may comprise, for example, a drill bit for earth boring or rock drilling, a rotary fixed-cutter bit for use in the oil and gas drilling industry, or a rolling cone drill bit, a hole opening tool, an expandable tool, a reamer or other earth boring tools.

Viewed from another aspect there is provided a drill bit or a cutter or a component therefor comprising the superhard polycrystalline construction defined above.

### BRIEF DESCRIPTION OF THE DRAWINGS

Various versions will now be described by way of example and with reference to the accompanying drawings in which:

FIG. 1 is a perspective view of an example of a PCD cutter element or construction for a drill bit for boring into the earth;

FIG. 2 is a schematic cross-section of a conventional portion of a PCD microstructure with interstices between the inter-bonded diamond grains filled with a non-diamond phase material;

FIG. 3a is a Raman spectrum plot of Raman shift and intensity of the starting material of an example method;

FIG. 3b is a plot showing the Xray diffraction pattern of the starting material of FIG. 3a;

FIG. 4a is a Raman spectrum plot of Raman shift and intensity of the a first material formed according to an example method;

FIG. 4b is a Raman spectrum plot of Raman shift and intensity of a second material formed according to an example method;

FIG. 4c is a Raman spectrum plot of Raman shift and intensity of a third material formed according to an example method;

FIG. 5a is a plot showing an XRD pattern of a fragment of a first sample produced according to an example method;

FIG. 5b is a plot showing an XRD pattern of a fragment of a second sample produced according to an example method;

FIG. 5c is a plot showing an XRD pattern of a fragment of a third sample produced according to an example method;

FIG. 5d is a plot showing an XRD pattern of a fragment of a fourth sample produced according to an example method;

FIG. 6 is a TEM image of a section though the material of a sample produced according to an example method;

FIG. 7 is a TEM image of a section though the material of a sample produced according to a further example method; and

FIG. 8 is an SEM image of a section though the material of a sample produced according to a stilfurther example method.

The same references refer to the same general features in all the drawings.

### DESCRIPTION

As used herein, a “super hard material” is a material having a Vickers hardness of at least about 28 GPa. Diamond and cubic boron nitride (cBN) material are examples of super hard materials.

As used herein, a “super hard construction” means a construction comprising a body of polycrystalline super hard material. In such a construction, a substrate may be attached thereto or alternatively the body of polycrystalline material may be free-standing and unbacked.

As used herein, polycrystalline diamond (PCD) is a type of polycrystalline super hard (PCS) material comprising a mass of diamond grains, a substantial portion of which are directly inter-bonded with each other and in which the content of diamond is at least about 80 volume percent of the material. As used herein, “interstices” or “interstitial regions” are regions between the diamond grains of PCD material. In some examples of PCD material, interstices between the diamond grains may be at least partly filled with a binder material comprising a catalyst for diamond. In some examples of PCD material, interstices or interstitial regions may be substantially or partially filled with a material other than diamond, or they may be substantially empty. PCD material may comprise at least a region from which catalyst material has been removed from the interstices, leaving interstitial voids between the diamond grains.

A “catalyst material” for a super hard material is capable of promoting the growth or sintering of the super hard material.

The term “substrate” as used herein means any substrate over which the super hard material layer is formed. For example, a “substrate” as used herein may be a transition layer formed over another substrate.

As used herein, the term “integrally formed” regions or parts are produced contiguous with each other and are not separated by a different kind of material.

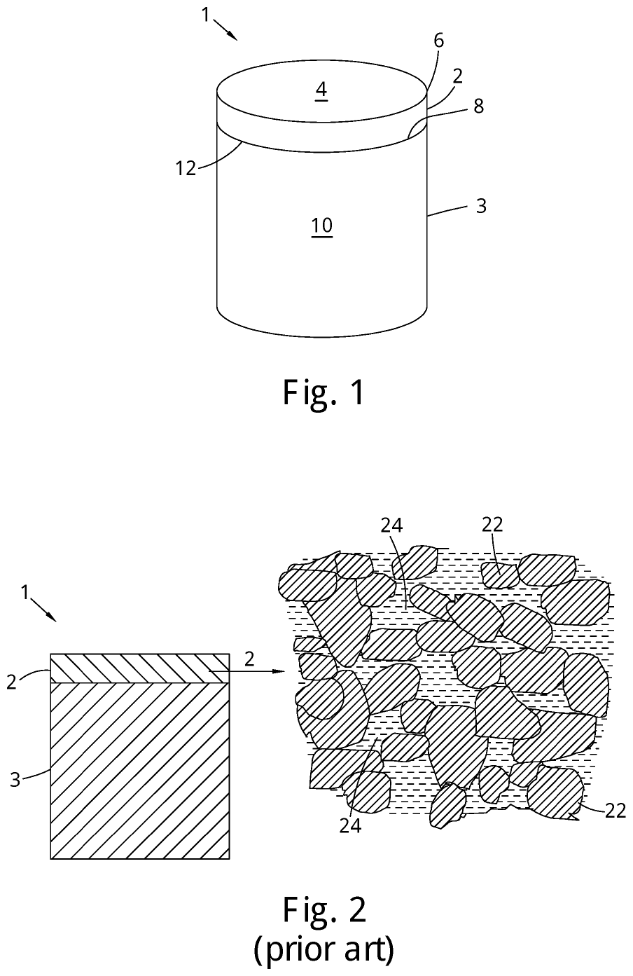

An example of a super hard construction is shown in FIG. 1 and includes a cutting element 1 having a layer of super hard material 2 formed on a substrate 3. The substrate 3 may be formed of a hard material such as cemented tungsten carbide. The super hard material 2 may be, for example, polycrystalline diamond (PCD), or a thermally stable product such as thermally stable PCD (TSP). The cutting element 1 may be mounted into a bit body such as a drag bit body (not shown) and may be suitable, for example, for use as a cutter insert for a drill bit for boring into the earth.

The exposed top surface of the super hard material opposite the substrate forms the cutting face 4, also known as the working surface, which is the surface which, along with its edge 6, performs the cutting in use.

At one end of the substrate 3 is an interface surface 8 that forms an interface with the super hard material layer 2 which is attached thereto at this interface surface. As shown in the example of FIG. 1, the substrate 3 may be generally cylindrical and has a peripheral surface 14 and a peripheral top edge 16.

The super hard material may be, for example, polycrystalline diamond (PCD) and the super hard particles or grains may be of natural and/or synthetic origin.

The substrate 3 may be formed of a hard material such as a cemented carbide material and may be, for example, cemented tungsten carbide, cemented tantalum carbide, cemented titanium carbide, cemented molybdenum carbide or mixtures thereof. The binder metal for such carbides suitable for forming the substrate 3 may be, for example, nickel, cobalt, iron or an alloy containing one or more of these metals. Typically, this binder will be present in an amount of 10 to 20 mass %, but this may be as low as 6 mass % or less. Some of the binder metal may infiltrate the body of polycrystalline super hard material 2 during formation of the compact 1.

As shown in FIG. 2, during formation of a conventional polycrystalline composite construction, the diamond grains are directly interbonded to adjacent grains and the interstices 24 between the grains 22 of super hard material such as diamond grains in the case of PCD, may be at least partly filled with a non-super hard phase material. This non-super hard phase material, also known as a filler material, may comprise residual catalyst/binder material, for example cobalt, nickel or iron. The typical average grain size of the diamond grains 22 is larger than 1 micron and the grain boundaries between adjacent grains is therefore typically between micron-sized diamond grains, as shown in FIG. 2.

The working surface or “rake face” 4 of the polycrystalline composite construction 1 is the surface or surfaces over which the chips of material being cut flow when the cutter is used to cut material from a body, the rake face 4 directing the flow of newly formed chips. This face 4 is commonly also referred to as the top face or working surface of the cutting element as the working surface 4 is the surface which, along with its edge 6, is intended to perform the cutting of a body in use. It is understood that the term “cutting edge”, as used herein, refers to the actual cutting edge, defined functionally as above, at any particular stage or at more than one stage of the cutter wear progression up to failure of the cutter, including but not limited to the cutter in a substantially unworn or unused state.

As used herein, “chips” are the pieces of a body removed from the work surface of the body being cut by the polycrystalline composite construction 1 in use.

As used herein, a “wear scar” is a surface of a cutter formed in use by the removal of a volume of cutter material due to wear of the cutter. A flank face may comprise a wear scar. As a cutter wears in use, material may progressively be removed from proximate the cutting edge, thereby continually redefining the position and shape of the cutting edge, rake face and flank as the wear scar forms.

One or more examples of nanopolycrystalline diamond (NPD) which may be used to replace the polycrystalline diamond structure shown in FIG. 2 in the cutter construction of FIG. 1 were prepared by the conversion at high pressure high temperature (HPHT) of multi-layer graphene platelet materials.

Examples are described in more detail below with reference to the following which are provided herein by way of illustration only and are not intended to be limiting.

Graphene nano-platelets, owing to their extremely high aspect ratio, have very high chemical and physical activities compared to their carbon allotropic partners. The surface of the graphene nano-platelets have various surface chemical structures, and any one or more hydroxyl, ketone, acetic, ester, groups could be formed on the graphene nano platelets. In some cases, when acids are involved in the production process, more chemical groups, such as chloric, sulfuric, nitric, fluoric, and phosphate groups, may be formed on the graphene nano-platelets. These complex surface chemical groups may inhibit graphene's carbon surface and may also activate the surface.

The activity of graphene nano-platelets may be determined under HTHP conditions, by encapsulating untreated or treated graphene nano-platelets inside Nb capsules, and subjecting the capsules to a variety of different pressures and temperatures. The resulting materials are then subjected to XRD analysis techniques to detect the presence of diamond. It has been determined in the various examples that graphene nano-platelets with oxygen terminated groups, such as hydroxyl, ketone, acetic, esters, have relatively low activity to partially convert into diamond, and fully hydrogenated graphene nano-platelets have more activity to partially convert into diamond and fluorinated graphene nano-platelets have even better activity to partially convert into diamond.

The activity of graphene nano-platelets may also be influenced by graphene size. In particular, the thinner the graphene nano-platelets, the higher the activity. However extremely thin graphene nano-platelets would expose a very high surface area to different chemical groups, and may induce excessive activity during diamond synthesis conditions. It was also determined in some examples that the activity of graphene nano-platelets may also be influenced by the aspect ratio of nano-platelets

The Z dimension (or thickness) of graphene nano-platelets used as the starting materials in the examples ranged from 0.1 nm to 15 nm and in some examples from 1 nm to 15 nm. The X-Y dimension of the graphene nano-platelets used ranged from 20 nm to 25000 nm, and in some examples ranged from 500 nm to 15000 nm. The aspect ratios of the platelets ranged from 200 to 25000, and in some examples ranged from 500 to 20000, or from 1000 to 15000.

For all examples, the graphene nano-platelets were cleaned with any one or more of ethanol, propanol, and distilled (DI) water to remove soluble substances. The mixture may be subjected to a sonication process to accelerate the cleaning process.

Chemical treatment to ‘activate’ the graphene nano-platelets may be applied to convert any oxygen related groups back to hydrogen and/or to reduce chemically bonded oxygen groups to below 5000 ppm, and in some examples to below 1000 ppm, and in other examples to below 500 ppm or below 200 ppm.

‘Activation’ of the graphene nano-platelets may further be enhanced by introducing chlorine, fluorine, and amine groups onto the surface of the platelets. In some examples, where a fluorine group is introduced, the amount introduced may be below 5000 ppm, or below 1000 ppm. In some examples here an amine group is introduced, the amount introduced may be below 10000 ppm, or below 5000 ppm, or below 2000 ppm.

In some examples, the graphene nano-platelets of the starting material may be mixed with other nano-materials, such as nano cBN materials which, once sintered may form nano-polycrystalline diamond composites. Thus, in such examples, an alternative nanocomposite compact material may be formed comprising at least two phases of which the first phase may be, for example nano polycrystalline diamond or nano monocrystalline diamond, and the second phase may be, for example nano polycrystalline cubic boron nitride or nano monocrystalline cubic boron nitride. In some examples, The nano polycrystalline diamond or nano monocrystalline diamond phase may form around 0.1 vol % to 99.9 vol % of the composite material, and the nano polycrystalline cubic boron nitride or nano monocrystalline cubic boron nitride phase may form from around 99.9 vol % to 0.1 vol %. Nano polycrystalline diamond or nano monocrystalline diamond phase may, for example, be formed of diamond grains having an average grain size of from around 1 nm to 999 nm, and the nano polycrystalline cubic boron nitride or nano monocrystalline cubic boron nitride phase may comprise cubic boron nitride grains having an average grain size of from around 1 nm to 999 nm.

In some examples, the diamond phase may be derived from conversion of graphene nano- platelets in the sintering process and the cubic boron phase may come directly from nano polycrystalline cubic boron nitride or nano monocrystalline cubic boron nitride particles included in the starting materials or from the conversion of hexagonal boron nitride during sintering.

In some examples, the second phase may be nano cubic silicon nitride or another nano material.

In some examples, in order to improve the control over the morphology of the nanopolycrystalline diamond composite structure, rather than mix pre-made hBN materials with graphene nano-platelets, hBN nanoparticles grown in situ on the graphene nano-platelets surface.

### EXAMPLE 1

Cleaned and chemically processed graphene nano-platelets with an average thickness of between around 5-15 nm (15-45 layers) and a lateral size of between around 5-25 pm were used as the starting materials and were encapsulated in a cylindrical hBN capsule and compressed using a multi-anvil press to a pressure ranging from 10 GPa to 15 GPa. At this elevated pressure, the encapsulated graphene nano-platelets were heated to a temperature ranging from 1600° C. to 2300° C. for about 5 minutes to 60 minutes. After the synthesis period, the capsule was quenched to room temperature and the pressure was brought back to ambient pressure. The compact was removed from the capsule and was subjected to a polishing treatment to expose the synthesized nano-polycrystalline diamond.

### EXAMPLE 2

Cleaned and chemically processed graphene nano-platelets with an average thickness of between around 5-15 nm (15-45 layers) and a lateral size of between around 5-25 μm were used as the starting materials and were encapsulated into an hBN capsule. The capsule was then placed into a multi-anvil press and subjected to a pressure of about 15 GPa. The pressurized capsule was then heated to around 2350° C. for about 2 minutes and it was noted that the resulting material turned from dark black to grey colour. The compact was removed from the capsule and was subjected to a polishing treatment to expose the synthesized nano-polycrystalline diamond. XRD and Raman analyses confirmed conversion of graphene into diamond and an SEM technique showed an average diamond grain size about 200 nm.

### EXAMPLE 3

Cleaned and chemically processed graphene nano-platelets with an average thickness of between around 5-15 nm (15-45 layers) and a lateral size of between around 5-25 μm were used as the starting materials and were encapsulated into an hBN capsule. The capsule was then placed into a multi-anvil press, subjected to a pressure of about 15 GPa, and the pressurized capsule was then heated to around 2050° C. for about 5 minutes. It was noted that the resulting material turned from dark black to grey colour. XRD and Raman analyses confirmed conversion of graphene into diamond and an SEM technique showed an average diamond grain size about 100 nm.

### EXAMPLE 4

Cleaned and chemically processed graphene nano-platelets with an average thickness of between around 5-15 nm (15-45 layers) and a lateral size of between around 5-25 μm were used as the starting materials and were encapsulated into an hBN capsule. The capsule was then placed into a multi-anvil press, subjected to a pressure of about 15 GPa, and the pressurized capsule was then heated to around 2000° C. for about 10 minutes. It was noted that the resulting material turned from dark black to grey colour. XRD and Raman analyses confirmed conversion of graphene into diamond and an SEM technique showed an average diamond grain size about 200 nm.

### EXAMPLE 5

Cleaned and chemically processed graphene nano-platelets with an average thickness of between around 5-15 nm (15-45 layers) and a lateral size of between around 5-25 μm were used as the starting materials and were encapsulated into an hBN capsule. The capsule was then placed into a multi-anvil press, subjected to a pressure of about 12 GPa, and the pressurized capsule was then heated to around 2000° C. for about 20 minutes. It was noted that the resulting material turned from dark black to grey colour. XRD and Raman analyses confirmed conversion of graphene into diamond and an SEM technique showed an average diamond grain size about 80 nm.

### EXAMPLE 6

Cleaned and chemically processed graphene nano-platelets with an average thickness of between around 5-15 nm (15-45 layers) and a lateral size of between around 5-25 μm were used as the starting materials and were encapsulated into an hBN capsule. The capsule was then placed into a multi-anvil press, subjected to a pressure of about 10 GPa, and the pressurized capsule was then heated to around 2000° C. for about 30 minutes. It was noted that the resulting material turned from dark black to grey colour. XRD and Raman analyses confirmed conversion of graphene into diamond and an SEM technique showed an average diamond grain size about 120 nm.

### EXAMPLE 7

Cleaned and chemically processed graphene nano-platelets with an average thickness of between around 5-15 nm (15-45 layers) and a lateral size of between around 5-25 μm were used as the starting materials and were encapsulated into an hBN capsule. The capsule was then placed into a multi-anvil press, subjected to a pressure of about 10 GPa, and the pressurized capsule was then heated to around 1800° C. for about 10 minutes. It was noted that the resulting material turned from dark black to grey colour. XRD and Raman analyses confirmed conversion of graphene into diamond and an SEM technique showed an average diamond grain size about 60 nm.

### EXAMPLE 8

1 g of graphene nano-platelets were placed in a beaker together with ethanol, and the mixture was sonicated with a sonication probe to obtain a graphene dispersion. In a separate beaker, 1 g of thoroughly cleaned cBN nanoparticles which had been obtained using crushing milling techniques were mixed with ethanol and the mixture was sonicated with a sonication probe to obtain a cBN nanoparticle dispersion. Both dispersions were then mixed together with the aid of a sonication process. The final mixture was then freeze-dried to obtain a fine powder mixture. The powder mixture was then treated in a furnace vacuum oven at 180° C. for 24 hours to remove any residual solvent and moisture.

The resulting mixture was then placed into an hBN capsule, and the capsule was placed into a multi-anvil press, and subjected to a loading pressure of about 15 GPa. The pressurized capsule was then heated to around 2100° C. for about 30 minutes. It was noted that the resulting material turned from black to grey in colour. XRD and Raman analyses confirmed conversion of graphene into diamond and an SEM technique showed an average diamond grain size of about 200 nm homogeneously mixed with cBN grains.

### EXAMPLE 9

1 g of graphene nano-platelets were placed in a beaker together with ethanol, and the mixture was sonicated with a sonication probe to obtain a graphene dispersion. In a separate beaker, 0.5 g of thoroughly cleaned cBN nanoparticles obtained using crushing milling techniques were mixed with ethanol, and the mixture was sonicated with a sonication probe to obtain a cBN nanoparticle dispersion. Both dispersions were then mixed together with aid of a sonication technique. The final mixture was then spray dried to obtain a fine powder mixture. The powder mixture was then treated in a furnace vacuum oven at 180° C. for 24 hours to remove any residual solvent and moisture.

The resulting mixture was then placed into an hBN capsule, and the capsule was placed into a multi-anvil press, and subjected to a loading pressure of about 10 GPa. The pressurized capsule was then heated to around 1800° C. for about 10 minutes. It was noted that the resulting material turned from black to grey in colour. XRD and Raman analyses confirmed conversion of graphene into diamond and an SEM technique showed an average diamond grain size of about 100 nm homogeneously mixed with cBN grains.

### EXAMPLE 10

1 g of graphene nano-platelets were placed in a beaker together with ethanol, and the mixture was sonicated with a sonication probe to obtain a graphene dispersion. In a separate beaker, 1 g of thoroughly cleaned turbostratic hBN nano-flakes were mixed with ethanol, and the mixture was sonicated with a sonication probe to obtain an hBN nano-flakes dispersion. Both dispersions were then mixed together with the aid of a sonication technique. The final mixture was then freeze dried to obtain a fine powder mixture. The powder mixture was then treated in a furnace vacuum oven at 220° C. for 24 hours to remove any residual solvent and moisture.

The resulting mixture was then placed into an hBN capsule, and the capsule was placed into a multi-anvil press, and subjected to a loading pressure of about 12 GPa. The pressurized capsule was then heated to around 2100° C. for about 20 minutes. It was noted that the resulting material turned from black to grey in colour. XRD and Raman analyses confirmed conversion of graphene into diamond and an SEM technique showed an average diamond grain size of about 100 nm homogeneously mixed with cBN grains.

### EXAMPLE 11

1 g graphene nano-platelets were placed in a beaker together with ethanol and methanol (1:1 in volume), and the mixture was sonicated with a sonication probe to obtain a graphene dispersion. In a separate beaker, 2.5 g boric acid and 2.5 g urea were dissolved into an ethanol and methanol mixture (1:1 in volume), and the graphene dispersion was then introduced into the boric acid solution and thoroughly mixed. The final mixture was then freeze dried to obtain a fine powder mixture. The powder mixture was then treated in a furnace at 700° C. for 10 hours under ammonia stream. The resulting material was hBN nanoparticle in situ coated graphene nano-platelets.

These coated graphene nano-platelets were then placed into an hBN capsule, and the capsule was placed into a multi-anvil press and subjected to a loading pressure of about 10 GPa. The pressurized capsule was then heated to around 1800° C. for about 7 minutes. It was noted that the resulting material turned from black to grey in colour XRD and Raman analyses confirmed conversion of graphene into diamond and an SEM technique showed an average diamond grain size of about 100 nm homogeneously mixed with cBN grains having an average grain size of around 100 nm.

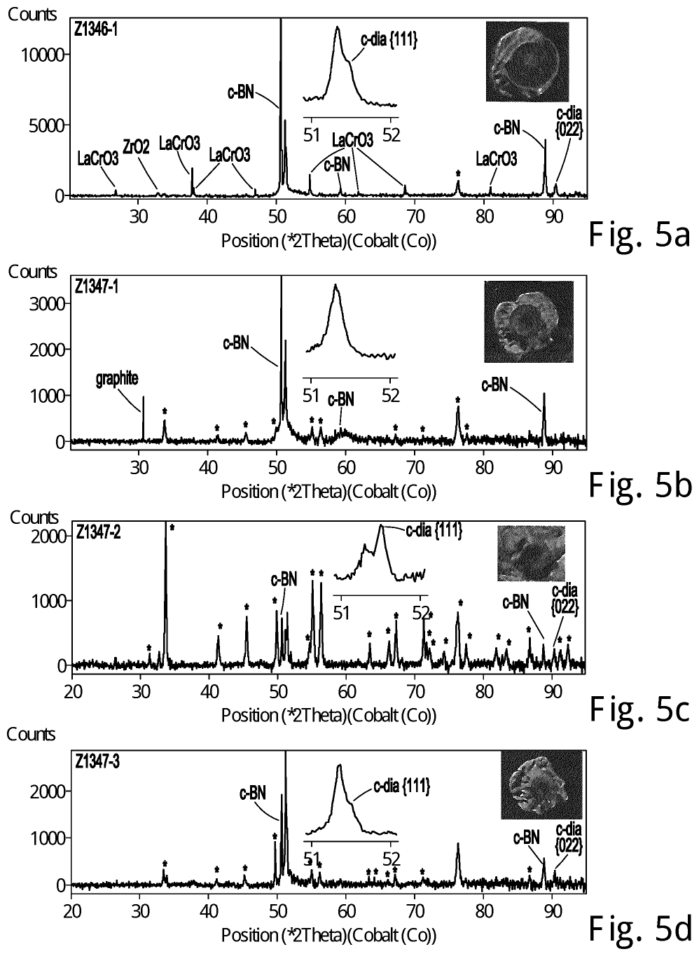

As mentioned above, the examples produced were subjected to Raman spectroscopy and x-ray diffraction (XRD) techniques to determine the extent of conversion and presence of diamond in the sintered product. The results for various samples are shown in FIGS. 4a to 5d, It was determined that total conversion had been achieved in all samples analysed as is evidenced by the clearly visible and significant diamond peak and the absence of graphite peaks.

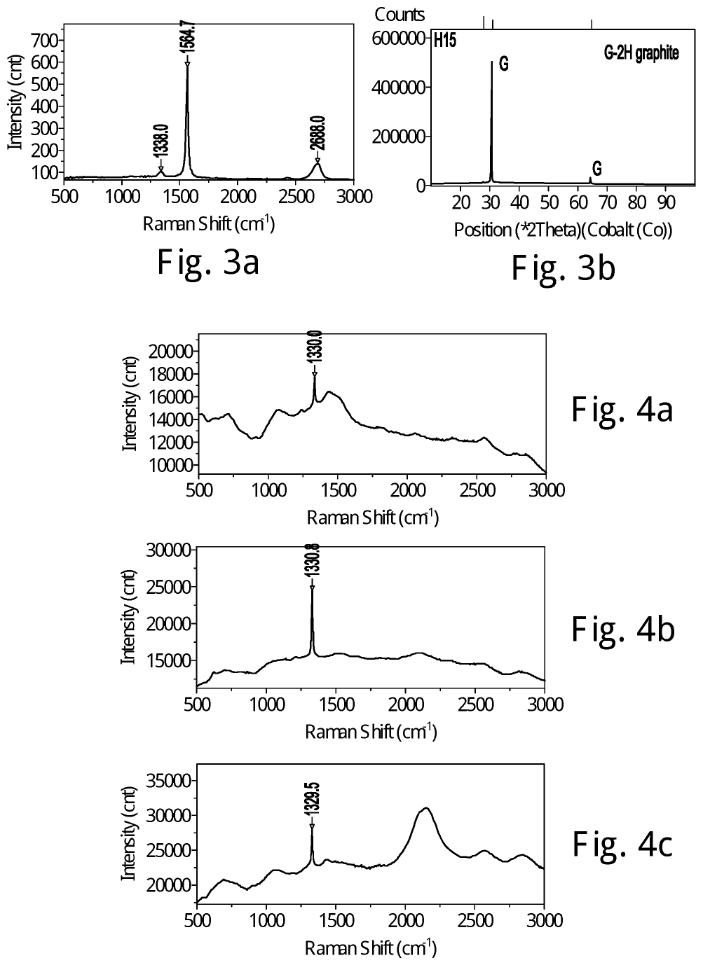

Raman spectra of the starting material and the various samples were recorded using LabRam Aramis spectrometer (Horiba Jobin Yvon), used as part of Oxford Materials Characterisation Service (OMCS). In particular, 530 nm laser light was used. To obtain the analysis of the starting materials, the results of which are shown in FIGS. 3a and 3b, the starting powder of graphene platelets was compacted before the measurement and spectra in two locations were recorded.

The X-ray diffraction (XRD) patterns were recorded for around 5 hours using an X'Pert PRO diffractometer (PANalytical) with a Co K_{α} source. The capsule fragments were fixed in sample holder with a putty and patterns of pure putty and of the empty holder were recorded earlier for calibration. In the XRD analysis of the starting materials, the starting material powder was compacted and placed on glass. Raw data was processed using HighScore Plus 3.0 software.

In the Raman analysis of various sample shown in FIGS. 4a to 4c, it will be seen that all spectra show a diamond peak at around 1330 cm⁻¹ and no sign of graphite peaks at 1350 cm⁻¹, 1580 cm⁻¹, 1620 cm⁻¹ or 2700 cm⁻¹.

The XRD patterns recorded from various surfaces of various sintered samples are shown in FIGS. 5a to 5d. The peaks may be assigned either to cubic diamond or to capsule materials.

The presence of 1330 cm⁻¹ diamond and lack of graphite peaks in the Raman spectra suggests complete conversion in all samples.

The examples formed may be attached in use to a substrate such as that shown in FIG. 1 to form a cutter element for abrasive applications, the NPD material being believed to have a combination of high abrasion and fracture performance compared to conventional PCD constructions formed with binder catalyst material such as that shown in FIG. 2.

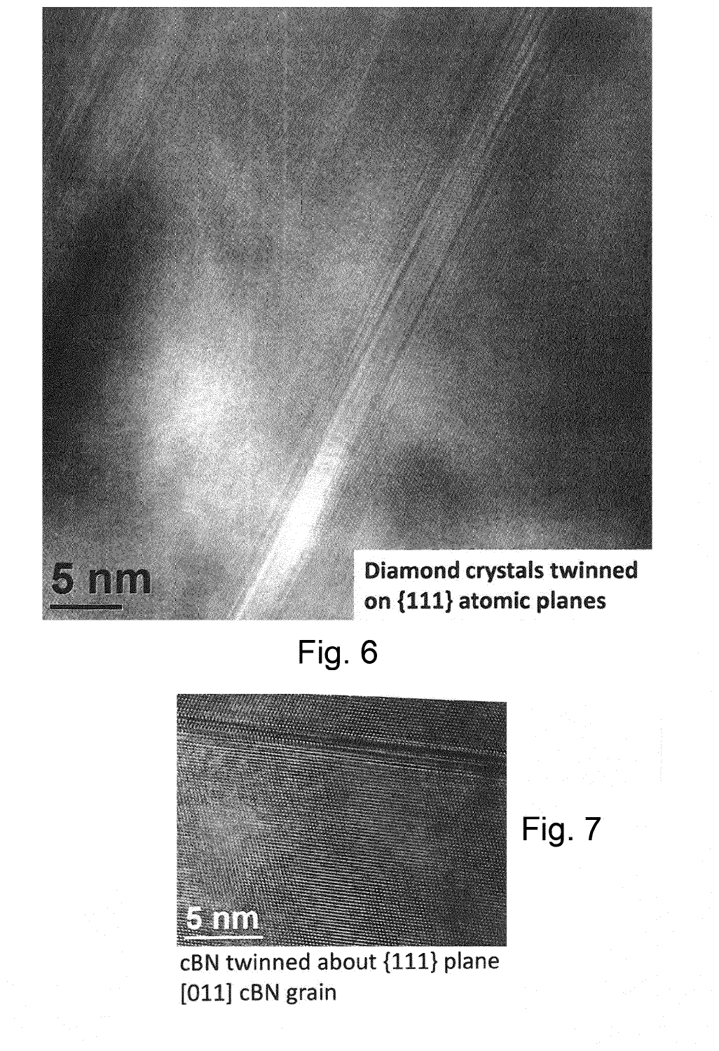

A TEM (transmission electron microscopy) analysis of the materials produced from the methods of the above described examples showed a plurality of twinned nano nano diamond crystals together with non-twinned crystals structures of nano diamond, as shown in FIG. 6. This was observed at sintering pressures of 10 GPa, 12 GPa and 15 GPa. Furthermore, a TEM analysis of the materials produced by examples 10 and 11 additionally showed twinned crystals of cBN in the sintered material, as shown in FIG. 7. Whilst not wishing to be bound by theory, it is believed that such twinned structures may increase the thermal stability of the sintered material as well as assisting in increasing various mechanical properties of the material such as toughness.

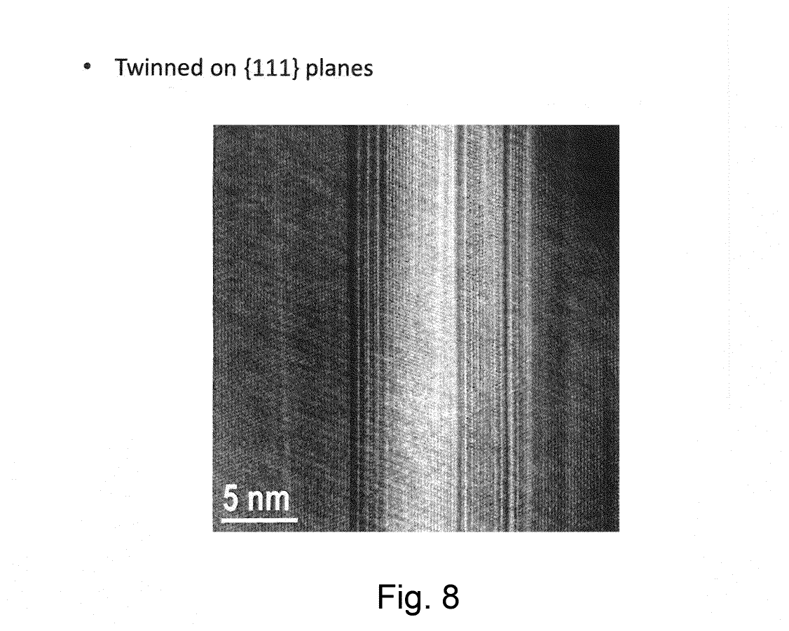

As will be seen from FIG. 8 which is an SEM mage of the sintered material according to one example, it is possible to generate a laminar (layered) structure in the material formed from, for example, the above-described examples 10 and 11.

While various versions have been described with reference to a number of examples, those skilled in the art will understand that various changes may be made and equivalents may be substituted for elements thereof and that these examples are not intended to limit the particular examples or versions disclosed.

1. A method of forming polycrystalline diamond, comprising:
placing a plurality of graphene nano-platelets into a capsule; and
subjecting the platelets to a pressure of around 10 GPa to around 20 GPa and a temperature of around 1600 degrees Celsius to around 3000 degrees Celcius to convert the graphene platelets to nano-polycrystalline diamond.

2. The method of claim 1 wherein the step of subjecting the platelets to said pressure and temperature comprises subjecting the platelets to a pressure of between around 10 GPa to around 15 GPa.

3. The method of claim 1, wherein the step of subjecting the platelets to said pressure and temperature comprises subjecting the platelets to said temperature and pressure for around 1 minute to around 60 minutes.

4. The method of claim 1, wherein the step of subjecting the platelets to said pressure and temperature comprises subjecting the platelets to a temperature of around 1600 degrees Celsius to around 2500 degrees Celsius.

5. (canceled)

6. The method of claim 1, wherein the step of placing a plurality of graphene nano-platelets into a capsule comprises placing graphene platelets having a lateral size of between around 5 microns to around 25 microns into the capsule.

7. The method of claim 1, wherein size of nanodiamonds produced is between around 1 nm to around 999 nm.

8. The method of claim 1, further comprising treating the platelets to reduce the presence of oxygen terminated groups on the surfaces of the platelets to less than around 5000 ppm.

9. The method of claim 1, further comprising treating the platelets to reduce the presence of oxygen terminated groups on the surfaces of the platelets to less than around 1000 ppm.

10. The method of claim 1, further comprising treating the platelets to reduce the presence of oxygen terminated groups on the surfaces of the platelets to less than around 500 ppm.

11. The method of claim 1, further comprising treating the platelets to reduce the presence of oxygen terminated groups on the surfaces of the platelets to less than around 200 ppm.

12. The method of claim 1, wherein the step of placing a plurality of graphene nano-platelets into a capsule comprises placing graphene platelets having an average thickness of between around 0.1 nm to around 15 nm into the capsule.

13. The method of claim 1, wherein the step of placing a plurality of graphene nano-platelets into a capsule comprises placing graphene platelets having an average thickness in the Z dimension of between around 1 nm to around 15 nm into the capsule.

14. The method of claim 1, wherein the step of placing a plurality of graphene nano-platelets into a capsule comprises placing graphene platelets having an average thickness in the X-Y dimension of between around 20 nm to 25000 nm in the capsule.

15. The method of claim 1, wherein the step of placing a plurality of graphene nano-platelets into a capsule comprises placing graphene platelets having an average thickness in the X-Y dimension of between around 500 nm to around 15000 nm into the capsule.

16. The method of claim 1, wherein the step of placing a plurality of graphene nano-platelets into a capsule comprises placing graphene platelets having an aspect ratio of between around 200 to 25000, or around 500 to 20000, or from 1000 to 15000 into the capsule.

17. The method of claim 1, further comprising cleaning the graphene nano-platelets prior to placing into the capsule.

18. The method of claim 17, wherein the step of cleaning comprises cleaning the platelets with any one or more of ethanol, propanol, and distilled water to remove soluble substances.

19. The method of claim 1, further comprising mixing the graphene nano platelets with a second phase material and the step of placing the graphene nano platelets into the capsule comprises placing the second phase material mixed with the graphene nano platelets into the capsule.

20. The method of claim 19, wherein the second phase material comprises any one or more of nano cBN grains, nano polycrystalline cubic boron nitride, nano monocrystalline cubic boron nitride, or nano cubic silicon nitride.

21. The method of claim 19, wherein the formed nano polycrystalline diamond comprises around 0.1 vol % to 99.9 vol % of the material, and the nano second phase material comprises between around 99.9 vol % to 0.1 vol %.

22. The method of claim 1, wherein size of nanodiamonds produced is between around 50 nm to around 200 nm.

23. The method of claim 1, wherein the step of subjecting the platelets to a pressure of around 10 GPa to around 20 GPa and a temperature of around 1600 degrees Celsius to around 3000 degrees Celcius to convert the graphene platelets to nano-polycrystalline diamond further comprises converting the graphene platelets to nano-polycrystalline diamond comprising a twinned crystal structure when viewed along a plane.

24. The method of claim 21, wherein the formed nano polycrystalline diamond comprises a plurality of nano polycrystalline diamond crystals having a twinned crystal structure and the nano second phase material comprises a plurality of nano sized crystals of the second phase material having a twinned crystal structure.

25. The method of claim 1, wherein the step of subjecting the platelets to a pressure of around 10 GPa to around 20 GPa and a temperature of around 1600 degrees Celsius to around 3000 degrees Celcius to convert the graphene platelets to nano-polycrystalline diamond comprises forming a nano-polycrystalline diamond material having a laminar layered structure.

26-35. (canceled)
